(19) United States
(12) Patent Application Publication
(10) Pub. No.: US 2025/0276242 A1
(43) Pub. Date: Sep. 4, 2025

(54) METHOD AND SYSTEM

(71) Applicant: Sony Interactive Entertainment Europe Limited, London (GB)

(72) Inventors: Pedro Federico Quijada LEYTON, London (GB); Owen Bruce KEYS, London (GB); Ashley John SANDERS, London (GB); Aron Giuseppe VISCIGLIA, London (GB); Simon Andrew St John BRISLIN, London (GB); David Erwan Damien UBERTI, London (GB); Nicholas Anthony Edward RYAN, London (GB)

(73) Assignee: Sony Interactive Entertainment Europe Limited, London (GB)

(21) Appl. No.: 19/064,105

(22) Filed: Feb. 26, 2025

(30) Foreign Application Priority Data
Mar. 1, 2024 (GB) 2402990.2

(51) Int. Cl. A63F 13/52; G06T 11/00

(52) U.S. Cl. CPC A63F 13/52; G06T 11/00; A63F 2300/8082

(57) ABSTRACT

A method and system is disclosed which enables avatars to be rendered in a realistic manner at different physical locations.

### CROSS-REFERENCE TO RELATED APPLICATIONS

The present application claims priority from British Patent Application No. 2402990.2 filed Mar. 1, 2024, the contents of which are incorporated herein by reference in its entirety.

### FIELD

The present invention relates to a method and system. Particularly, but not exclusively, the present invention relates to a computer-implemented method and system. Further particularly, but not exclusively, the present invention relates to a computer-implemented method of providing an augmented reality environment.

### BACKGROUND

Augmented reality is starting to penetrate more and more aspects of our lives. It is beneficial because it enables us to consume and interact with others without the limitations of physical structures.

Aspects and embodiments are conceived with the foregoing in mind.

### SUMMARY

Aspects relate to providing an augmented reality environment. The augmented reality environment may be an augmented reality entertainment environment where content is displayed. Examples of content may be a video stream or a video game. Alternatively, the provided augmented reality environment may be deployed for other purposes where content may be data or imagery.

Viewed from a first aspect, there is provided a computer-implemented method of providing an augmented reality environment. The method may be implemented by a processing resource. The processing resource may be software or hardware implemented and may be implemented using one or more modules. Each step may be implemented using a different module. The modules may be co-located or distributed over a wide geographical area.

The method may comprise initialising an augmented reality environment at a first physical location. Initialising an augmented reality environment may comprise establishing and allocating the processing, software and hardware resources necessary to provide the augmented reality environment. This may combine resources from the processing resource and another computing resource, e.g. an augmented reality headset. The first physical location may be a room or an outdoor environment which is used as a real space where an augmented reality environment is to be implemented. An augmented reality headset may be used to initialise an augmented reality environment. An augmented reality headset may comprise modules and sensors which can track the position, pose and orientation of a user who dons the headset. An augmented reality headset may also be configured with object tracking and object identification modules which may implement suitable techniques such as, for example, simultaneous location and mapping (SLAM) techniques.

The method may further comprise associating an avatar representation with each of at least two users. One or more of the at least two users may be located at the first physical location. Each of at least two users may mean one avatar representation is provided for each user. An avatar representation is a graphical representation of a user which is rendered inside an augmented reality environment to represent the presence of that user in the augmented reality environment. An avatar representation may be configured in accordance with user preferences indicated in a user profile associated with a respective user. The association of the avatar representation with a user may comprise identifying that an avatar representation has been established for that user. It may also mean setting up the avatar representation. The set-up of the avatar representation may be by a user via a suitably configured application or it may be automated based on an image of the user processed by suitable software.

At least two users means two or more users. Each of the two or more users may be present at respective distinct physical locations, where one of the physical locations may be the first physical location. The method in accordance with the first aspect may be repeated for each of the respective physical locations.

The method may further comprise determining at least one physical constraint associated with the first physical location. A physical constraint may comprise data indicating the presence of one or more objects at a location. The data may indicate the relative position of the object relative to the user or another object (e.g. an augmented reality headset). The data indicating the presence of one or more objects may comprise coordinates describing the position of the object relative to the user. Changes in the user's position and/or orientation may generate a re-determination of the at least one physical constraint associated with the respective physical location.

The processing resource may deploy techniques using SLAM and computer vision to identify physical objects present at a location. Such objects may be items of furniture or other objects, such as walls or other barriers. The determination may comprise scanning the physical environment to obtain data associated with such objects. Example objects may include chairs, sofas, tables, lamps etc.

Artificial neural networks (ANNs) or convolutional neural networks (CNNs) may be used to establish the identity of an object based on data identified at a physical location. In other words, the physical object may be identified using a trained model. Such a trained model may be trained on images of the physical object. The trained model may deploy an artificial neural network (ANN) or a convolutional neural network (CNN), for example. ANNs can be hardware-(neurons are represented by physical components) or software-based (computer models) and can use a variety of topologies and learning algorithms.

ANNs usually have three layers that are interconnected. The first layer consists of input neurons. Those neurons send data on to the second layer, referred to a hidden layer which implements a function and which in turn sends the output neurons to the third layer. There may be a plurality of hidden layers in the ANN. With respect to the number of neurons in the input layer, this parameter is based on training data.

The second or hidden layer in a neural network implements one or more functions. For example, the function or functions may each compute a linear transformation or a classification of the previous layer or compute logical functions. For instance, considering that the input vector can be represented as x, the hidden layer functions as h and the output as y, then the ANN may be understood as implementing a function f using the second or hidden layer that maps from x to h and another function g that maps from h to y. So the hidden layer's activation is f(x) and the output of the network is g (f(x))

CNNs can be hardware or software based and can also use a variety of topologies and learning algorithms.

A CNN usually comprises at least one convolutional layer where a feature map is generated by the application of a kernel matrix to an input image. This is followed by at least one pooling layer and a fully connected layer, which deploys a multilayer perceptron which comprises at least an input layer, at least one hidden layer and an output layer. The at least one hidden layer applies weights to the output of the pooling layer to determine an output prediction.

Either of the ANN or CNN may be trained using images of physical objects which may be identified or need to be identified in accordance with the method. The training may be implemented using feedforward and backpropagation techniques.

The method may comprise rendering the avatar representations associated with the at least two users in the augmented reality environment based on the at least one physical constraint associated with the first physical location. The avatar representations may be rendered using any suitable technique. The physical constraint may indicate that an object is present at a first position in a first physical location and the avatar representation will not be rendered at that position. However, such an object may not be present at a second location and this may enable the avatar representations to be rendered in different locations and positions. The physical constraint may indicate the presence of a specific object and the avatar representations may be rendered in accordance with the specific object. For example, if the specific object is a chair, the avatar representations may be rendered in a seated position on the chair. Further poses may be rendered such as, for example, the avatar may be rendered such that their legs are crossed.

A method in accordance with the first aspect enables an augmented reality environment to be provided where avatar representations associated with first and second users are rendered using information about physical constraints at a location, i.e. the presence of objects such as furniture. This enables a more “sensible” and physically realistic rendering of the avatar representations to be implemented as the avatars are not rendered over such physical objects but can instead be rendered next to such objects.

The method may further comprise initialising an augmented reality environment at a second physical location. The second physical location may have different dimensions or layout from the first physical location. The method may further comprise determining at least one physical constraint associated with the second physical location. The physical constraint may be the presence of a physical objects, such as, for example, an item of furniture.

The physical constraint may comprise data indicating the presence of one or more objects at a location. The data may indicate the relative position of the object relative to the user or another object (e.g. an augmented reality headset). The data indicating the presence of one or more objects may comprise coordinates describing the position of the object relative to the user. Changes in the user's position and/or orientation may generate a re-determination of the at least one physical constraint associated with the respective physical location.

The processing resource may deploy techniques using SLAM and computer vision to identify physical objects present at a location. Such objects may be items of furniture or other objects, such as walls or other barriers. The determination may comprise scanning the physical environment to obtain data associated with such objects. Example objects may include chairs, sofas, tables, lamps etc.

The method may further comprise rendering the avatar representations associated with the at least two users in the augmented reality environment at the second physical location based on the at least one physical constraint associated with the second physical location, which may be distinct from the first physical location. It may be distinct in terms of dimensions but also distinct in respect of the presence of objects which may or may not be present at the second physical location whereas those same objects are present at the first physical location. The physical constraint determined from the first physical location may therefore be distinct from the physical constraint determined from the second physical location. That is to say, the avatar representations can be rendered in a different way at the second physical location if the physical constraints allow it to be so. In other words, physical objects present at the first physical location may necessitate rendering the avatar representations in a first position and layout whereas the absence of those physical objects at a second physical location may allow a different position and layout to be adopted for the rendering of the avatar representations. Respective movements from the first user to interact in the first augmented reality environment may be rendered in a different way at the second augmented reality environment.

The physical constraint may indicate the presence of a specific object and the avatar representations may be rendered in accordance with the specific object. For example, if the specific object is a chair, the avatar representations may be rendered in a seated position on the chair. Further poses may be rendered such as, for example, the avatar may be rendered such that their legs are crossed.

Determining at least one physical constraint associated with a physical location may comprise scanning the area encompassed by the physical location to determine the presence of at least one object (e.g. an item of furniture). This may be implemented using simultaneous location and mapping (SLAM) techniques. The data captured from the SLAM techniques may be fed to an ANN or CNN for object recognition and detection to be performed. Other object identification techniques may be used to determine the presence of an object. The method may further comprise determining the location of the object. The method may comprise determining the dimensions of the object. This may be by estimation based on the scan data obtained from the area. The location may be expressed relative to an augmented reality headset and the relative location of the object may be tracked relative to the location of the headset. The method may further comprise generating a constraint data set associated with the object. A constraint data set may identify an object, the location of the object and the dimensions of the object. Further analysis may be applied to identify the colour or texture of the object. The determination may be repeated for a plurality of physical objects at the physical location (either or both of the first or second physical locations). This generates a constraint data set associated with each object in the plurality of objects at the respective first or second location.

Rendering the avatar representation in the augmented reality environment may comprises rendering the avatar representation at a location which does not coincide with an object in the physical location.

Rendering the avatar representation in an augmented reality environment comprises rendering the avatar representation in a pose determined by the physical constraint at the respective physical location. For example, in a first location the first avatar representation may be rendered in a pose which makes them look as if they are looking to their right or left whereas in a second augmented reality environment they may be looking straight ahead if the physical constraint associated with the second physical location enables face-to-face interaction to be implemented.

The rendering of the avatar representation in the respective first and second physical locations may be adjusted responsive to user input via user input devices associated with the respective avatar representations. The input devices may be any suitable computing device. The input devices may comprise augmented reality headsets.

The rendering of the avatar representations may be adjusted based on the first and second physical location. This may be because the differing physical constraints at the first and second physical locations enable different renderings to be implemented

Rendering the avatar representations in the augmented reality environment at any physical locations may depend on a number of factors. The scale, position and orientation of the avatar representations rendered in an augmented reality environments may depend on settings and preferences which are defined by the processing resource or a user profile associated with one or more of the avatar representations. For example, a setting or a preference may indicate that an avatar representation should be in a seated position. If a seat or chair or sofa cannot be identified at a location, one or more of the avatar representations may be rendered in a seated position on a virtual chair which is also rendered in a respective augmented reality environment. In another example, if an insufficient number of seats or chairs or sofas are identified at a location, avatar representations are rendered in the seated position on the respective seat or chair or sofa and the remaining avatar representations are rendered on virtual chairs.

The avatar representations may be rendered in accordance with a preset configuration. For example, the avatar representations may be arranged in a line, in a circle, in face-to-face orientation or in another configuration which be determined using a user profile where a preference over such a configuration and layout may be designated.

The augmented reality environment may comprises an augmented reality entertainment environment which may be used, for example, to stream a video game or other content item.

Systems and non-transitory storage mediums may also be provided.

### DESCRIPTION

An embodiment will now be described, by way of example only, and with reference to the following drawings in which:

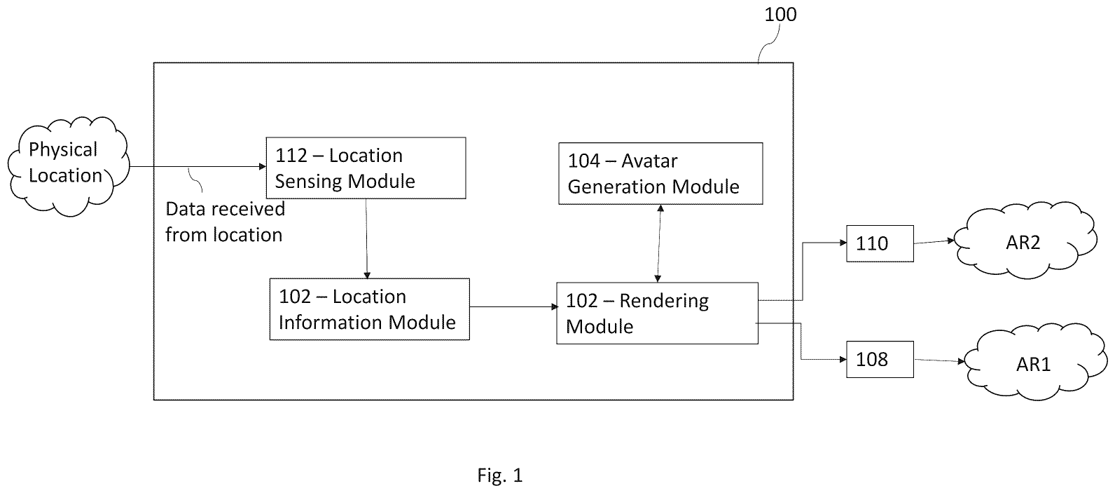

FIG. 1 illustrates a processing resource which can be used to implement a method in accordance with the embodiment;

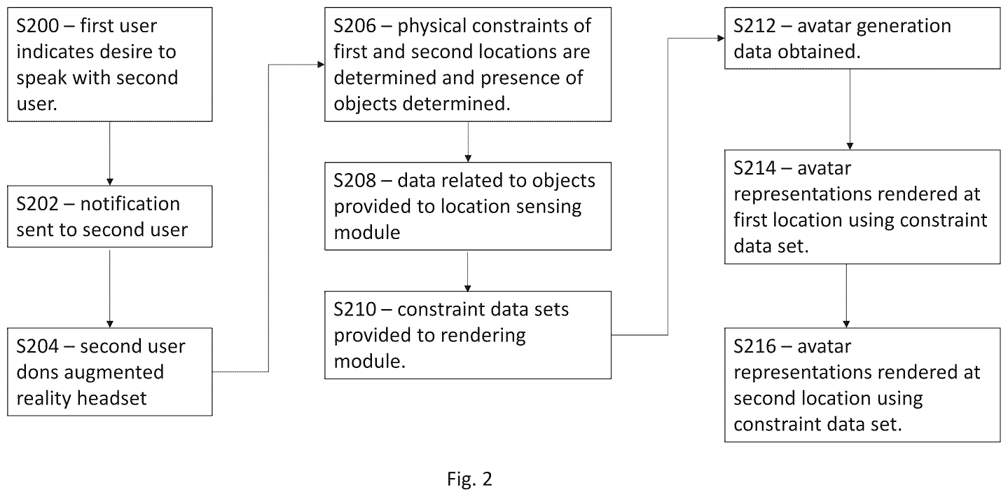

FIG. 2 illustrates a flow of steps which are used to implement a method in accordance with the embodiment;

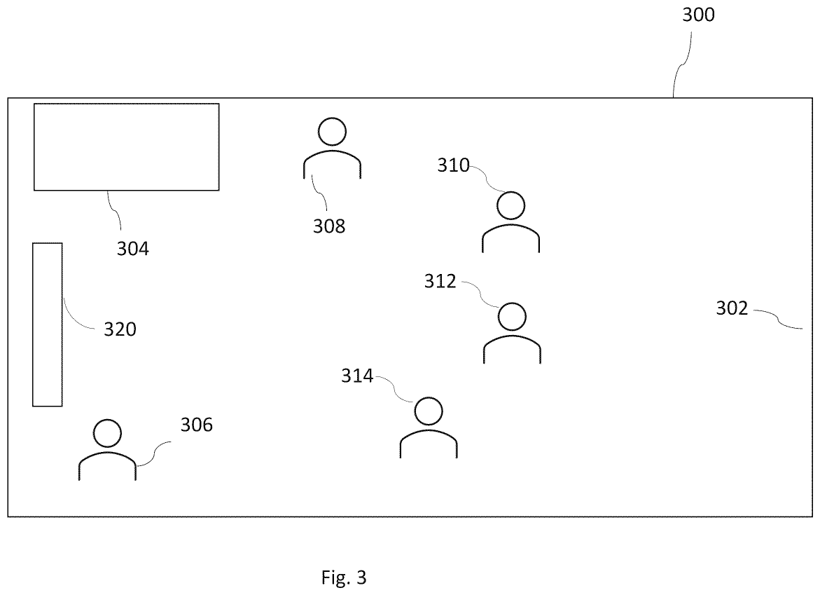

FIG. 3 illustrates a layout of a first physical location which may be used in the implementation of a method in accordance with the embodiment;

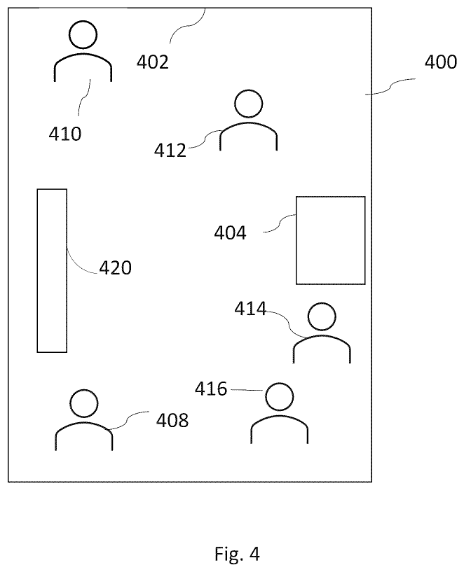

FIG. 4 illustrates a layout of a second physical location which may be used in the implantation of a method in accordance with the embodiment; and

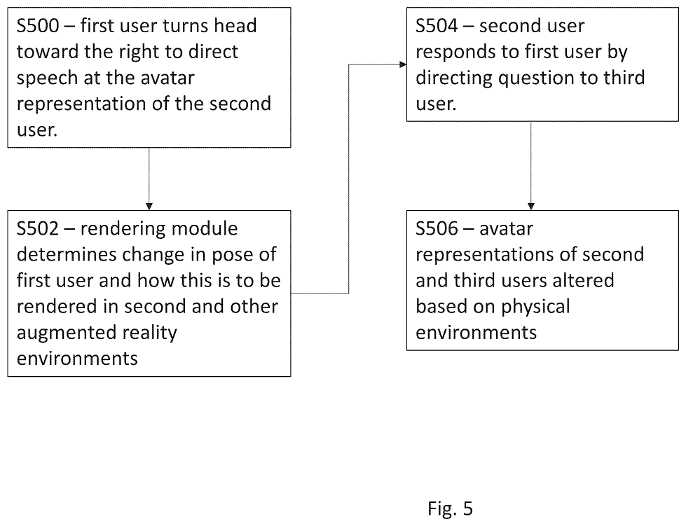

FIG. 5 describes how the rendering of avatars may be adjusted based on physical location.

We will now illustrate, with reference to FIG. 1, a processing resource 100 which can be used to provide an augmented reality entertainment environment. Although we describe the processing resource using the example of an augmented reality entertainment environment, it will be understood that the processing resource 100 is not limited to entertainment environments.

Processing resource 100 may be implemented using hardware or software. Processing resource 100 comprises a rendering module 102, an avatar generation module 104, a location information module 106 and a location sensing module 112. The modules of the processing resource 100 may interact using any suitable data communications protocol, e.g. the world-wide web.

The processing resource 100 may be configured to interact with a first augmented reality headset 108 associated with a first user and a second augmented reality headset 110 associated with a second user to provide augmented reality environments at respective first and second physical locations at which the users are located.

The interaction between the processing resource 100 and the respective augmented reality headsets may be implemented using any suitable data communications protocol. The processing resource 100 may be located on either of the first or second augmented reality headsets and interact with the other using an appropriate data communications protocol. One or more of the modules which make up the processing resource 100 may be distributed in that they may not be co-located but rather distributed over a larger geographic area.

The rendering module 102 is configured to generate data which can be used by a respective computing device (e.g. an augmented reality headset) to produce an augmented reality environment. The rendering module 102 may transmit the data to the computing device which processes the data to render the augmented reality environment at a physical location. The data may relate to content and/or virtual objects for display inside the augmented reality environment. The data is transmitted to the computing device in a suitable format such as, for example, GITF format.

The avatar generation module 104 is configured to generate avatar representations of users who have a profile associated with the processing resource 100. The avatar representations may be configured by the users to look in a pre-defined way. That is to say, the avatar representations may comprise a plurality of visual aspects (e.g. hair colour, eye colour, clothing) which are selected based on input from an associated user. The avatar generation module 104 generates the avatar representations and transmits them as avatar representation data to the rendering module 102 so that the avatar representation of a respective user can be rendered in a respective augmented reality environment by the augmented reality headset. A suitable file format for avatar representations may be graphical interchange format (GIF).

The location sensing module 112 is configured to apply object detection techniques to a location based on data received from that location. The data received from the location may comprise simultaneous location and mapping (SLAM) measurements determined from the location by an augmented reality headset or it may already have been received from the location prior to a present initialisation of an augmented reality environment at the location. The SLAM measurements may be used to determine the presence of physical objects, e.g. furniture, at the location and the location sensing module 112 is configured to process the SLAM measurements to determine the position of the physical objects at the respective location. More will be said about this below with reference to FIGS. 2 to 4.

The location information module 106 is configured to receive data from the location sensing module using any suitable data communications protocol. The location information module 104 processes the data to identify where at the physical location there are objects so a constraint data set can be generated. The constraint data set identifies the location of each object at the location and this is provided to the rendering module 102.

The rendering module 102 may combine the data received from the avatar generation module and the data received from the location information module 108 to identify positions where respective avatar representations can be rendered in a respective augmented reality environment. More will be said about this below with reference to FIGS. 2 to 4.

The rendering module 102 may provide different sets of rendering data to the respective augmented reality headsets. This reflects the different constraint data sets generated at each location. We now describe how the processing resource can be used to provide an augmented reality environment where first and second users respectively associated with augmented reality headsets 108 and 110 wish to interact but from distinct physical locations which generate distinct constraint data sets as they encompass distinct physical objects in different positions. A first augmented reality environment (AR1) is rendered using augmented reality headset 108 associated with first user at first physical location. A second augmented reality environment (AR2) is rendered using augmented reality headset 110 associated with second user at second physical location.

In a first step S200, first user indicates, via a user interface associated with first augmented reality headset 108, that they wish to speak with a second user associated with second augmented reality headset 110. The user interface may be provided on a display unit associated with the augmented reality headset 108. Alternatively or additionally, the user interface may be provided via an augmented reality environment responsive to the first user donning the augmented reality headset 108.

In a step S202, the second user is provided with a notification that the first user wishes to speak with them. The notification may be provided via a further user interface at a suitable computing device. The second user may respond with a confirmation and then don second augmented reality headset 110 to initiate the session with the first user. This is step S204. Other methods of response may also be utilised. For example, the second user may not need to don the augmented reality headset 110 to initiate the session with the first user. They may communicate with the first user via a user interface and an avatar representation corresponding to the second user may be rendered in the first augmented reality environment to represent that user even though they are not using an augmented reality headset at their location.

The first and second users can use respective applications to establish the interaction, e.g. the second user can click on a respective link in the provided notification and this leads to the initialisation of an first augmented reality environment at the first physical location, i.e.

the location where the first user is physically present and the initialisation of a second augmented reality environment at the second physical location, e.g., the location where the second user is physically present.

In step S206, the respective augmented reality headsets utilise SLAM techniques to establish the physical boundaries and layouts of the respective physical locations. This is to determine the presence of physical objects such as furniture and walls which would provide constraints on the physical location. The data obtained from the use of the SLAM techniques can also be used to identify objects at the physical location. Both the first and second physical locations are different from one another. We can illustrate this using FIG. 3 and FIG. 4.

The data received from the SLAM techniques may be fed to a suitably configured and trained ANN or CNN which is used to identify the object. Other object identification techniques may be used.

FIG. 3 illustrates the layout 300 of the first physical location, i.e. where the first user is located. The first physical location is a rectangular room with walls on four sides and a door 302 to provide access to the room. A table 304 is positioned directly ahead of the first user.

FIG. 4 illustrates the layout 400 of the second physical location, i.e. where the second user is located. The second physical location is a rectangular room but much narrower than the first physical location. A door 402 is positioned at one end of the room and a table 404 is positioned along a boundary wall.

The presence of respective walls, tables and doors are determined in step S206 where the SLAM techniques are used to identify the objects within the respective first or second physical location. The data captured in step S206 is provided to the location sensing module 112 in step S208 which identifies the location of the respective objects relative to the respective augmented reality headset as donned by the first or second user. The size and dimensions of the physical objects may also be determined using the data gathered using the SLAM techniques.

The location sensing module 112 provides the location data corresponding to the objects to the location information module 106 which generates a constraint data set for the respective first and second physical location. The constraint data set identifies where in the room an object, such as a wall or a piece of furniture, is present. That is to say, the constraint data set is the result of a determination of a physical constraint of the respective physical location, i.e. which objects are there and how close walls are to the respective first or second augmented reality headset.

In a step S210, the location information module 106 provides the constraint data sets to the rendering module 102. On receiving the constraint data sets, the rendering module 102 obtains avatar generation data from the avatar generation module 104. This is step S212. The avatar generation data is the data used to render the avatars corresponding to the first and second users is the respective augmented reality environments. The rendering module 102 determines the location at which the avatar representation of the second user will be rendered relative to the avatar representation of the first user.

In a step S214, the avatars corresponding to the first and second users are rendered at the first location illustrated in FIG. 3 with layout 300. The constraint data set corresponding to the first physical location is used to determine that a table 304 is directly in front of first user. Therefore, the rendering module 102 determines that directly in front of first user would not be a good place to render the avatar representation of the second user for the duration of their session. The rendering module 102 determines that a location to the right of first user would be a good place to render the avatar representation of the second user. This may be determined based on a user-defined preference in the profile of the first user where a preference for face-to-face interaction is indicated. Using this preference, the avatar representation of the first user is calculated based on a distance (e.g. Euclidean distance between the end of the table (based on the constraint data set) and the nearest point the avatar representation of the second user could be rendered without it overlapping with the table 304). Alternatively or additionally, system or user preferences associated with the first or second user may indicate a preference for avatar representations to be in a seated position. If a seat is identified at a location as a physical object, the avatar representation may be rendered in a seated position even if they are not in a seated position at their physical location. Alternatively or additionally, if a seat cannot be identified, respective avatar representations can be rendered in a seated position in a virtual chair rendered in the augmented reality environment.

Other adjustments to the position, pose, scale and orientation of the avatar representations rendered in an augmented reality environment may also be based on system or user preferences. For example, the height of a respective user may be used to scale an avatar accordingly to be taller or shorter in height than another user.

The avatar representation of first user is enumerated with reference numeral 306 and the avatar representation of second user is enumerated with reference numeral 308. That is to say, in the rendering of the avatar representations in the augmented reality environment initialised at the first physical location, the constraint data set determined from the scanning of the first location is used to determine good and bad places to render the avatar representation whilst first and second users interact in the augmented reality environment. The avatar representations are then rendered in the augmented reality environment at the first physical location in the determined positions as illustrated in FIG. 3 by providing the associated position data to the augmented reality headset 108 which then renders the avatar representations of the first and second users accordingly.

In a step S216, the avatar representations are rendered at the second location illustrated using layout 400 in FIG. 4. The constraint data set is used to determine that the room is much narrower but that the table 404 is not directly in front of the first user but is rather to the right hand side of the first user. This enables the rendering module 102 to determine that, at the second physical location, the avatar representation of the second user may be rendered directly in front of the avatar representation of the first user, whereas at the first physical location this could not be the case as the constraint data set determined from the first physical location would be used to determine that table 304 was at that location relative to the avatar representation of the first user. Alternatively or additionally, the second user may have indicated in an associated user profile that they prefer face to face interaction. Alternatively or additionally, the second user may have indicated they have no preference.

The avatar representations are then rendered in the augmented reality environment at the second physical location by providing the associated position data to the augmented reality headset 110 which then renders the avatar representations of the first and second users accordingly at the determined positions. The avatar representation of the first user is enumerated as 408 and the avatar representation of the second user is enumerated as 410.

That is to say, in the physical environment where the first user is located, the avatar representation corresponding to the second user is displayed to the right of the avatar representation corresponding to the first user. However, in the physical environment where the second user is located, the avatar representation corresponding to the second user is displayed directly in front of the avatar representation corresponding to the first user. This is because respective physical constraints at each physical location means that avatars are rendered differently. The avatars cannot be rendered identically at each physical location as the result would not be realistic, i.e. an avatar would be rendered over a table or inside a wall.

In summary, steps S200 to S216 describe how the physical constraints of a location are used to render avatar representations to enable interactions take place.

This also means that when first user looks at the avatar representation of the second user, they turn their head to the right. That is to say, the avatar representation of the first user is posed in the first augmented reality environment at the first physical location as if it is looking to the right. However, in the second augmented reality environment at the second physical location, no adjustment in the pose of the avatar representation of the first user takes place as it will be looking straight ahead at the avatar representation of the second user. This will now be described in more detail below where we will describe how relative pose may be adjusted based on the physical environment of the respective first or second user.

A configuration of avatars may be selected by a user. This would mean that avatar representations are rendered in accordance with a specific layout. Example layouts would include conference, where they are face-to-face, or in alignment, i.e. where avatar representations are rendered to be next to one another in a straight line.

Steps S200 to S216 may be repeated for any number of users. For example, third, fourth and fifth users may join the augmented reality session which is established between the first and second users and avatar representations corresponding to those users may also be rendered in corresponding physical environments based on the physical constraints associated with those environment as well as physical constraints associated with their own environments. This is illustrated in both of FIGS. 3 and 4.

In FIG. 3, avatar representation 310 corresponding to third user, avatar representation 312 corresponding to fourth user and avatar representation 314 corresponding to fifth user are shown distributed around the first physical location inside the first augmented reality environment rendered by augmented reality headset 108.

In FIG. 4, avatar representation 412 corresponding to third user, avatar representation 414 corresponding to fourth user and avatar representation 416 corresponding to fifth user are shown distributed around the second physical location inside second augmented reality environment render by augmented reality headset 110.

In FIG. 4, it is illustrated that the avatar representations are arranged relative to a content item 420. Content item 420 may be rendered inside the second augmented reality environment (and the first augmented reality environment where it is enumerated with reference numeral 320). Content item 420 may be a stream of an item of content such as, for example, a video stream or a video game or even a data feed. Content item 420 may be an image of a scan, for instance, or an image of a person.

In the first augmented reality environment, i.e. the layout illustrated in FIG. 3, the first user may speak to the avatar representation of the second user, i.e. avatar representation 308. This may be part of a discussion about the content item 320. We will now describe how this interaction is rendered at the first and second augmented reality environments with reference to FIG. 5.

In a step S500, the first user turns their head toward the right to direct speech at the avatar representation of the second user 308. The alteration in the pose of the first user is determined by the augmented reality headset 108. The change in pose is fed to the rendering module 102 as an alteration in the pose of the avatar representation corresponding to the first user. The position of each avatar in the first augmented reality environment is used to estimate that the first user is highly likely to be addressing the avatar representation of the second user. In another example, a full 90 degree turn to the right (of the augmented reality headset) would be determined as highly likely to be the first user addressing the avatar representation of the fifth user.

In a step S502, the rendering module 102 is configured, responsive to receiving the determination of a change in the pose of the first user, to determine how this is to be rendered in the augmented reality environments corresponding to the other users. For example, in the second augmented reality environment, avatar representation 408 (corresponding to the first user) and avatar representation 410 (corresponding to the second user) are face-to-face as set out above. The rendering module 102 therefore determines that no change in the pose of avatar representation 408 is necessary. However, the rendering module 102 may determine that a change in the pose of avatar representations 412, 414 and 416 is necessary if respective measures are received of head movements from corresponding users as they follow the conversation between the first and second users across respective augmented reality environments. The rendering module 102 may then adjust the pose of those avatar representations in both the first and second augmented reality environments accordingly. The adjustment in pose may be different between the two augmented reality environments dependent on the relative position of the avatar representations.

In a step S504, the second user responds to the first user by directing a question to the avatar representation 310 of the third user. This is represented by the second user turning their head toward the avatar representation of the third user. The rendering module 102 would determine this change in pose using measurements received from the augmented reality headset 110.

Responsive to this determination, the rendering module 102 would transmit a signal, in a step S506, to the first augmented reality environment to enable the avatar representation of the second and third users to be altered in pose so that their heads are turned toward each other. Similarly, a signal would be transmitted to the second augmented reality environment to enable the avatar representation of the second and third users to be altered in pose so that their heads are turned toward each other. The adjustment will be different as the relative difference in position between the second and third avatar representations are distinct across the first and second augmented reality environments as determined by respective constraint data sets determined from the physical environments.

Steps S500 to S506 can be repeated as the interaction continues between the first and second users and the other users corresponding to the other avatar representations.

That is to say alterations in the pose, orientation and position of the avatar representations may be rendered in a first augmented reality environment but not in another. Each physical space is unique and therefore avatar representations will need to be posed differently in each. Scale, orientation and position of avatar representations are provided based on each individual location.

Although particular embodiments of this disclosure have been described, it will be appreciated that many modifications/additions and/or substitutions may be made within the scope of the claims.

It should be noted that the above-mentioned aspects and embodiments illustrate rather than limit the disclosure, and that those skilled in the art will be capable of designing many alternative embodiments without departing from the scope of the disclosure as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The disclosure may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer-implemented method of providing an augmented reality environment, the method implemented by a processing resource, the method comprising:
initialising an augmented reality environment at a first physical location;
associating an avatar representation with each of at least two users;
determining at least one physical constraint associated with the first physical location; and
rendering the avatar representations associated with the at least two users in the augmented reality environment based on the at least one physical constraint associated with the first physical location.

2. A method according to claim 1, wherein the method further comprises:
initialising an augmented reality environment at a second physical location;
determining at least one physical constraint associated with the second physical location; and
rendering the avatar representations associated with the at least two users in the augmented reality environment at the second physical location based on the at least one physical constraint associated with the second physical location.

3. A method according to claim 2 wherein the second physical location is distinct from the first physical location.

4. A method according to claim 2 wherein the at least one physical constraint associated with the second physical location is distinct from the at least one physical constraint associated with the first physical location.

5. A method according to claim 1, wherein determining at least one physical constraint associated with a physical location comprises:
scanning the area encompassed by the physical location to determine the presence of at least one object;
determining the location of the object; and
generating a constraint data set associated with the object.

6. A method according to claim 5, wherein the object is identified as an item of furniture.

7. A method according to claim 5, wherein the determination is repeated for a plurality of physical objects at the physical location to generate a constraint data set associated with each object in the plurality of objects.

8. A method according to claim 5, wherein the constraint data set comprises positional data associated with the object.

9. A method according to claim 1 wherein rendering the avatar representation in an augmented reality environment comprises rendering the avatar representation at a location which does not coincide with an object in the physical location.

10. A method according to claim 1, wherein rendering the avatar representation in an augmented reality environment comprises rendering the avatar representation in a pose determined by the physical constraint at the respective physical location.

11. A method according to claim 2, wherein the rendering of the avatar representation in the respective first and second physical locations is adjusted responsive to user input via user input devices associated with the respective avatar representations.

12. A method according to claim 11, wherein the rendering of the avatar representations is adjusted based on the first and second physical location.

13. A method according to claim 1, wherein the avatar representations are rendered in accordance with a preset configuration.

14. A method according to claim 1, wherein the augmented reality environment comprises an augmented reality entertainment environment.

15. A method according to claim 14, wherein the augmented reality entertainment environment is used to stream a video game.

16. A system configured to implement the method of claim 1.

17. A non-transitory storage medium comprising instructions, which, when executed by a processing resource, cause the processing resource to implement the method of claim 1.
